(19) United States
(12) Patent Application Publication
(10) Pub. No.: US 2024/0163624 A1
(43) Pub. Date: May 16, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventor: YUJI TSUCHIDA, TOKYO (JP)

(21) Appl. No.: 18/549,980

(22) PCT Filed: Jan. 18, 2022
(86) PCT No.: PCT/JP2022/001485

§ 371 Date: Sep. 11, 2023

(30) Foreign Application Priority Data
Mar. 18, 2021 (JP) 2021-044564

(51) Int. Cl. H04S 7/00

(52) U.S. Cl. CPC H04S 7/00; H04S 2400/11

(57) ABSTRACT

The present technique relates to an information processing device, an information processing method, and a program that allow a plurality of players at remote sites to perform a high-level ensemble.

An information processing device according to the present technique includes: an acoustic processing unit that performs acoustic processing on an acoustic signal obtained by collecting sounds in spaces where a plurality of users performing together are located, the acoustic processing being performed to convolve the transfer characteristics of a sound according to the positional relationship among the users in a virtual space; and an output control unit that causes a sound based on a signal generated by the acoustic processing to be output from an output device used by each of the users. The present technique is applicable to, for example, a computer for performing a remote ensemble.

### TECHNICAL FIELD

The present technique relates to an information processing device, an information processing method, and a program and particularly relates to an information processing device, an information processing method, and a program that allow a plurality of players at remote sites to perform a high-level ensemble.

### BACKGROUND ART

Ensembles at remote sites have been attempted with, for example, the principal objective of controlling infectious diseases. An ensemble by players at remote sites is called a remote ensemble.

### CITATION LIST

### Patent Literature

### [PTL 1]

JP H11-331992A

### SUMMARY

### Technical Problem

In remote ensembles by a large number of players in an orchestra or the like, the players often play instruments under environments having relatively small room capacities, for example, in a studio booth or a sound-proof chamber at home. In ensembles under environments having small room capacities and short reverberation times, it is difficult for players to obtain proper acoustic feedback to a played sound unlike during performance under wide environments such as a concert hall and an orchestra rehearsal room.

Moreover, a player hears combined (mixed) sounds of other players through headphones or the like and thus cannot ensure a sense of distance or a sense of direction and suffers from difficulty in obtaining acoustic feedback about the played sounds of other players.

Thus, it is difficult to achieve a high-level remote ensemble with the harmonization of, for example, the timing of playing, the level of sound, and the degree of sound drawl.

The present technique has been devised in such circumstances and is configured to achieve a high-level ensemble by a plurality of players at remote sites.

### Solution to Problem

An information processing device according to an aspect of the present technique includes: an acoustic processing unit that performs acoustic processing on an acoustic signal obtained by collecting sounds in spaces where a plurality of users performing together are located, the acoustic processing being performed to convolve the transfer characteristics of a sound according to the positional relationship among the users in a virtual space; and an output control unit that causes a sound based on a signal generated by the acoustic processing to be output from an output device used by each of the users.

In an aspect of the present technique, acoustic processing is performed on an acoustic signal obtained by collecting sounds in spaces where a plurality of users performing together are located, the acoustic processing being performed to convolve the transfer characteristics of a sound according to the positional relationship among the users in a virtual space, and a sound based on a signal generated by the acoustic processing is output from an output device used by each of the users.

### BRIEF DESCRIPTION OF DRAWINGS

FIG. 1 illustrates a configuration example of a remote ensemble system according to an embodiment of the present technique.

FIG. 2 illustrates an example of devices provided in a booth.

FIG. 3 illustrates an example of transmission of voice data.

FIG. 4 illustrates a state of players performing in an ensemble.

FIG. 5 shows an example of a virtual concert hall.

FIG. 6 shows an example of the positions of the players on the stage.

FIG. 7 shows an example of the positions of the players.

FIG. 8 shows an example of an HRIR.

FIG. 9 shows an example of how a played sound is heard.

FIG. 10 illustrates an example of how the played sound of a player is heard.

FIG. 11 is a block diagram illustrating a configuration example of the remote ensemble system.

FIG. 12 is a block diagram illustrating a configuration example of a transmission controller.

FIG. 13 is a block diagram illustrating a configuration example of an information processing device.

FIG. 14 shows an example of a BRIR used for acoustic processing.

FIG. 15 is a flowchart for explaining the processing of the transmission controller.

FIG. 16 is a flowchart for explaining the processing of the information processing device used by a player.

FIG. 17 illustrates another configuration example of the remote ensemble system.

FIG. 18 is a block diagram illustrating a configuration example of a reproducing device in which a recorded acoustic signal is used.

FIG. 19 illustrates another configuration example of the transmission controller.

FIG. 20 is a block diagram illustrating a configuration example of computer hardware.

### DESCRIPTION OF EMBODIMENTS

An embodiment for implementing the present technique will be described below.

The description will be made in the following order.
1. Configuration of remote ensemble system
2. Configuration of each device
3. Operation of each device
4. Modification Example

### 1. Configuration of Remote Ensemble System

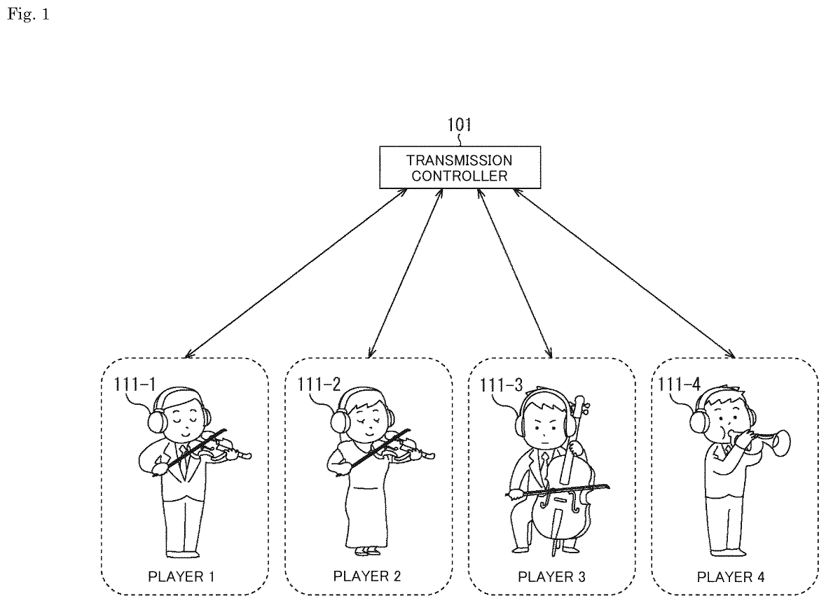

FIG. 1 illustrates a configuration example of a remote ensemble system according to an embodiment of the present technique.

The remote ensemble system of FIG. 1 is a system used for a so-called remote ensemble performed by players at remote sites.

The example of FIG. 1 illustrates players 1 to 4 who play in an orchestra. The player 1 and the player 2 play the violin and the player 3 play the cello. The player 4 plays the trumpet.

The number of players is not limited to four. Actually, a remote ensemble is performed by more players using more kinds of instruments. The number of players varies among band formations.

The remote ensemble system of FIG. 1 is configured such that a plurality of information processing devices used by the players 1 to 4 are connected to a transmission controller 101. The transmission controller 101 and the information processing devices may be connected through wire communications or radio communications.

The players 1 to 4 perform in remote spaces. For example, different booths prepared in a studio are used as spaces for performance. In FIG. 1, rectangles of broken lines surrounding the players 1 to 4 indicate that the players 1 to 4 play in the different booths.

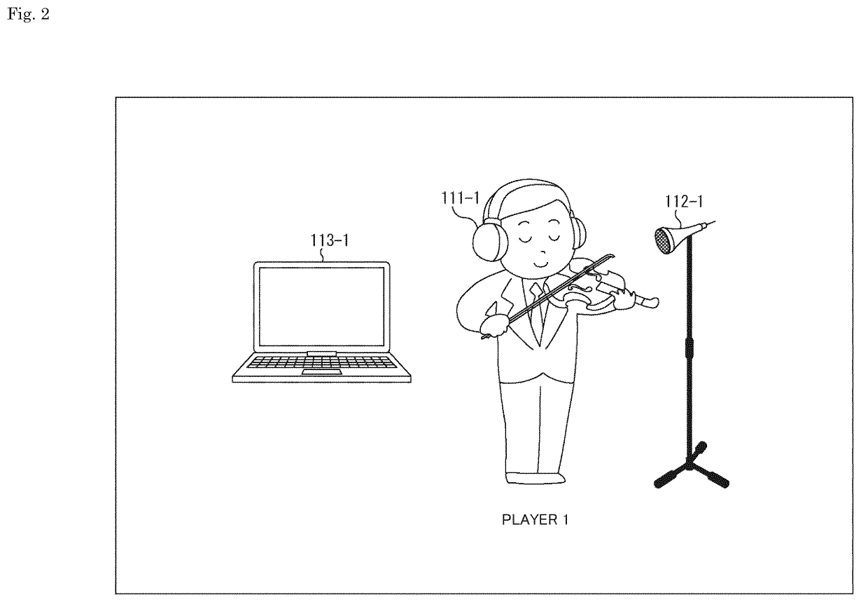

FIG. 2 illustrates an example of devices provided in the booth.

As illustrated in FIG. 2, headphones 111-1, a microphone 112-1, and an information processing device 113-1 are provided in the booth of the player 1. The headphones 111-1 and the microphone 112-1 are connected to the information processing device 113-1 configured with a PC, a smartphone, or a tablet or the like. The microphone 112-1 is directly connected also to the transmission controller 101 as appropriate.

The headphones 111-1 are output devices put on the head of the player 1. The headphones 111-1 output a played sound of the player 1 and played sounds of other players under the control of the information processing device 113-1. Earphones (inner ear headphones) may be used as output devices instead of the headphones.

The microphone 112-1 collects a played sound of the player 1.

Furthermore, the booths of the players 2 to 4 are each provided with three devices: headphones, a microphone, and an information processing device as in the booth of the player 1.

In the booth of the player 2, headphones 111-2, a microphone 112-2, and an information processing device 113-2 are provided. In the booth of the player 3, headphones 111-3, a microphone 112-3, and an information processing device 113-3 are provided. In the booth of the player 4, headphones 111-4, a microphone 112-4, and an information processing device 113-4 are provided.

Hereinafter, the headphones 111-1 to 111-4 that do not need to be distinguished from one another will be collectively referred to as headphones 111. Other devices provided in the remote ensemble system will be also collectively described.

As described above, in the remote ensemble system of FIG. 1, each of the players wears the headphones and plays over the microphone while listening to played sounds output from the headphones.

The transmission controller 101 of FIG. 1 controls the transmission of the acoustic signals of played sounds from the players 1 to 4, the transmission controller 101 being connected to the devices provided in the booths.

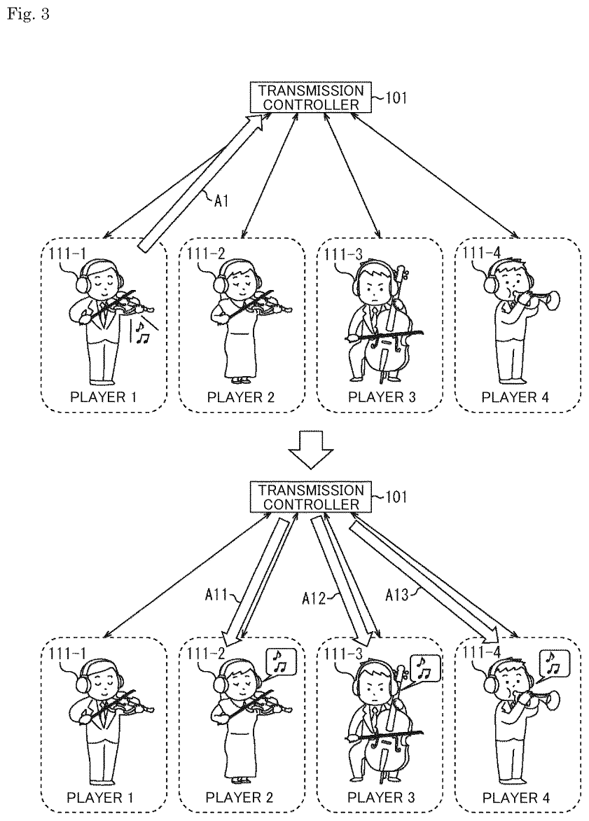

For example, when the acoustic signal of the played sound of the player 1 is transmitted from the information processing device 113-1 in response to the performance of the player 1 as indicated by an arrow A1 in the upper part of FIG. 3, the transmission controller 101 transmits the acoustic signal of the played sound of the player 1 to the information processing devices 113-2 to 113-4 as indicated by arrows A11 to A13 in the lower part of FIG. 3. In the information processing devices 113-2 to 113-4, the acoustic signal transmitted from the transmission controller 101 is subjected to signal processing and then the played sound of the player 1 is output from the headphones 111-2 to 111-4.

Also in the performance of the players 2 to 4, the acoustic signals of played sounds collected by the microphones provided in the booths are transmitted via the transmission controller 101 to the information processing devices 113 used by other players.

The transmission controller 101 manages the position and orientation (direction) of each player on a virtual space. The virtual space is a virtual three-dimensional space set as a location for an ensemble. An acoustic space designed for an ensemble, for example, a concert hall or an orchestra rehearsal room is set as the virtual space. Hereinafter, a virtual space for an ensemble of all players including the players 1 to 4 will be referred to as a virtual concert hall as appropriate.

The positions of the players 1 to 4 on the virtual concert hall are set at, for example, positions corresponding to instruments played by the players 1 to 4. The positions of the players 1 to 4 on the virtual concert hall may be automatically set by the transmission controller 101 or may be set by operating, for example, the information processing device 113 by the players. The positions on the virtual concert hall are represented by three-dimensional coordinates.

Information about the positions of the players on the virtual space is provided to the information processing devices 113 used by the players and is managed therein, the positions being managed by the transmission controller 101.

In the information processing devices 113 having received the acoustic signals transmitted from the transmission controller 101, acoustic processing is performed on the acoustic signals such that each player hears the played sounds of other players from the positions of other players on the virtual concert hall and a played sound of each player and played sounds of other players are obtained while reproducing the acoustic characteristics of the virtual concert hall. The acoustic processing includes rendering such as VBAP (Vector Based Amplitude Panning) based on position information and convolution using a BRIR (Binaural Room impulse Response).

By performing acoustic processing using the BRIR according to the positional relationship between the position of each player and the positions of other players, each player feels as if the played sounds of other players were heard from the positions of the players. Moreover, the players feel as if they were playing in the virtual concert hall. The BRIR will be described later.

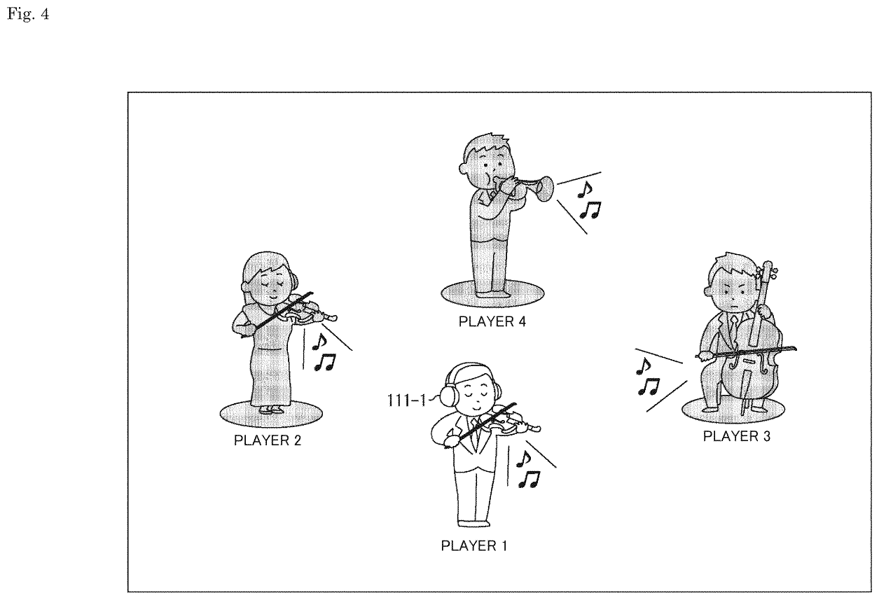

FIG. 4 illustrates a state of the players performing in an ensemble.

As illustrated in FIG. 4, for example, the player 1 performs while feeling as if the sounds of the players 2 to 4 playing with the player 1 were heard from directions corresponding to the positional relationships with the players 2 to 4. In FIG. 4, shadows under the feet of the players 2 to 4 indicate that the players 2 to 4 performing with the player 1 are not present in the same booth as the player 1.

The played sounds of other players are heard from positions corresponding to positions in the virtual concert hall. Thus, even the player with the headphones 111 can play while feeling a sense of distance and a sense of direction from the played sounds of other players.

By performing acoustic processing using the BRIR according to the acoustic characteristics of the virtual concert hall, each player can obtain proper acoustic feedback about played sounds of other players as in performance in a real concert hall. The acoustic feedback includes, for example, the timing of playing, a sense of distance, a sense of direction, a stress, and the degree of drawl of sound.

In other words, even if each player plays in a relatively small booth while other players are located at remote sites, each player can achieve high-level performance as in a real ensemble in a concert hall.

Virtual Concert Hall

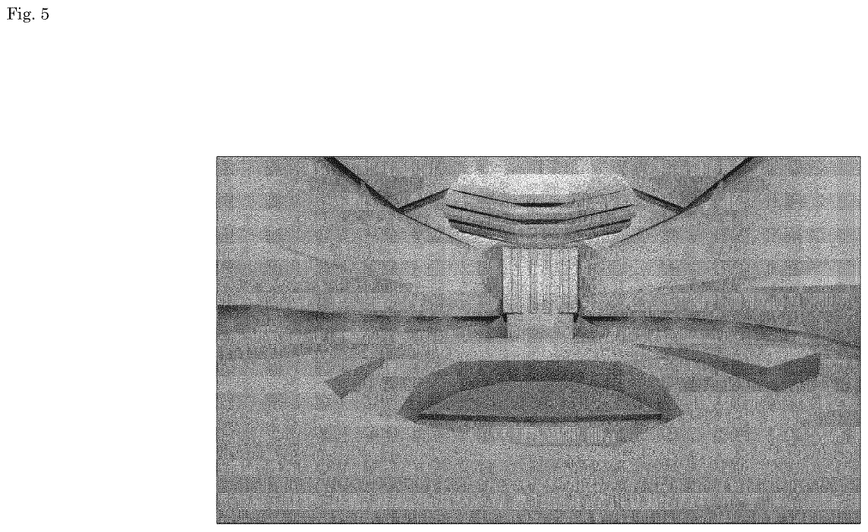

FIG. 5 shows an example of the virtual concert hall.

As shown in FIG. 5, for example, a virtual three-dimensional space with the central stage is set as a virtual concert hall. A plurality of seats are virtually provided around the stage.

A virtual position of a player in a remote ensemble is set on the stage of the virtual concert hall.

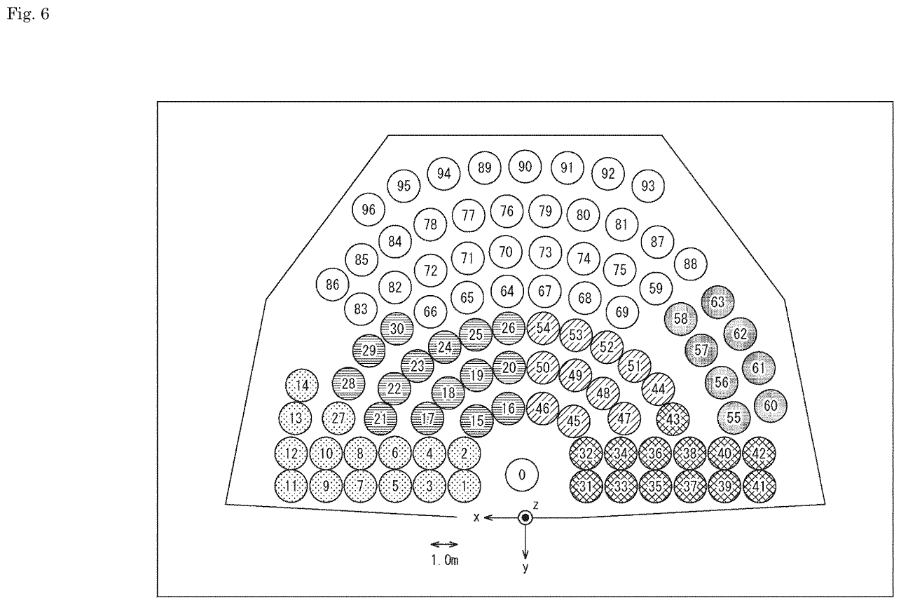

FIG. 6 shows an example of the positions of players on the stage.

In FIG. 6, the positions of circles surrounded by numbers are the virtual positions of a conductor and players. Like a position P0 indicating a position surrounding a number “0,” the positions on the stage will be described, as appropriate, using numbers surrounded by circles.

In FIG. 6, the position P0 on the stage indicates the position of the conductor. For example, the coordinates of the position of each player are set with the origin point located at the position of the conductor. In the example of FIG. 6, the positions of 96 points at positions P1 to P96 are set on the stage as the positions of players.

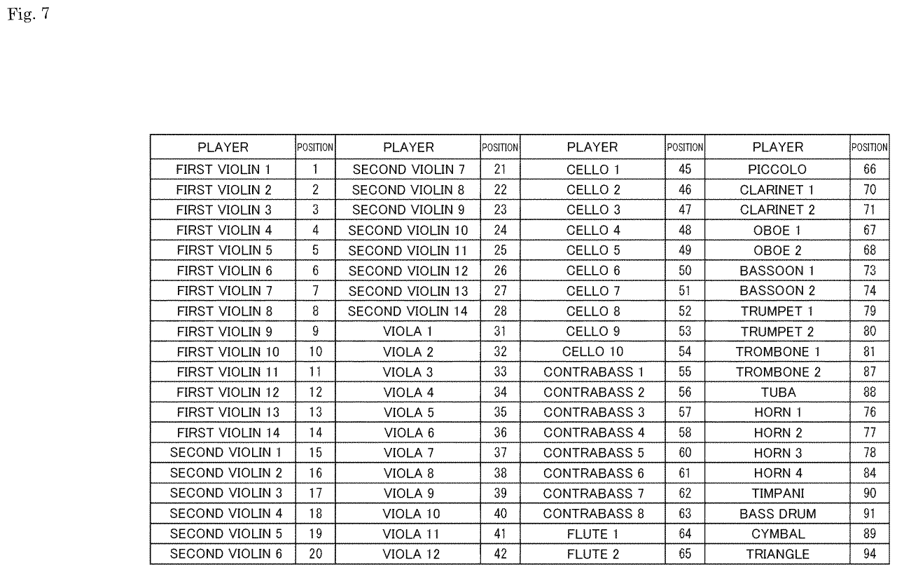

FIG. 7 shows an example of the positions of the players.

As shown in FIG. 7, for example, the position of a player of a first violin 1 is the position P1. The position P1 is located in the front of the stage (FIG. 6).

For example, the player of the first violin 1 sets the position of the player at the position P1 by operating the information processing device 113 or the like before starting performance.

The players of other instruments also set the positions of the players before starting performance. The playing positions may be set by the administrator of the remote ensemble system instead of the players.

BRIR

The BRIR used for the convolution of the acoustic signal will be described below.

A player N (N is any number) virtually disposed at each position on the stage hears a played sound of a player M (M is any number) with a convoluted BRIR from the player M to the player N, the player M being located at the position of a sound source. For an RIR (Room Impulse Response) from the player M to the player N, transfer characteristics with a convoluted HRIR (Head-Related Impulse Response) corresponding to the direction of arrival of a played sound are used as a BRIR from the player M to the player N.

The RIR from the player M to the player N represents the transfer characteristics of direct sound from the player M to the player N and the transfer characteristics of reflected sound according to the shape of the virtual concert hall, construction materials, the position of the player N, and the position of the player M. Reflected sound represents initial reflected sound or rear reverberant sound of sound from a sound source at the position of the player M.

The HRIR represents transfer characteristics until the time when a sound output from a specified sound source reaches both ear parts of the player N.

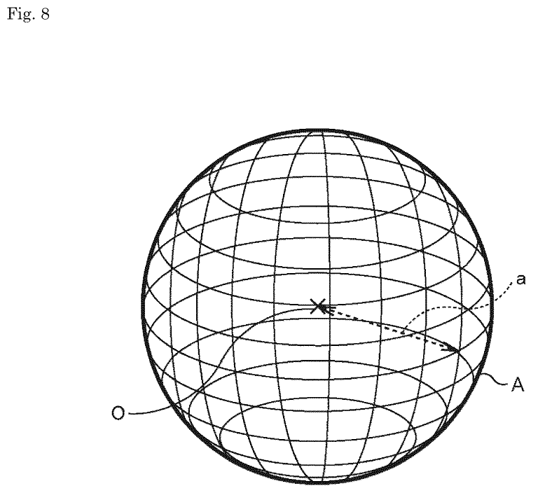

FIG. 8 illustrates an example of HRIRs.

As illustrated in FIG. 8, left-ear HRIRs from sound sources to the left ear and right-ear HRIRs from the sound sources to the right ear are prepared in a database, the sound sources being disposed over a celestial sphere with respect to a position O of the player N. In FIG. 8, the plurality of sound sources are disposed at a distance a with respect to the position O. For example, the position O is the center position of the head of the player N.

From among the HRIRs from the source sources disposed over the celestial sphere, the left-ear HRIRs and the right-ear HRIRs from the sound sources are convolved to various sounds included in RIRs, the sound sources corresponding to the arrival directions of various sounds such as a direct sound, an initial reflected sound, and a rear reverberant sound that are included in the RIRs. For example, for a predetermined reflected sound included in the RIRs, convolution is performed on the left-ear HRIR and the right-ear HRIR from the sound source on a line connecting the position O and the position of the sound source of the reflected sound in the virtual concert hall. Various sounds included in RIRs are represented by monophonic signals.

It is desirable that the distance a to the sound source of the HRIR prepared in the database agrees with a distance from the position O to the position of the sound source of a predetermined reflected sound. However, if the position of the sound source of a reflected sound is located at a predetermined distance or larger from the position O, an error is negligible.

The direction of the RIR with the convoluted HRIR is corrected in consideration of the orientation of a player listening to a played sound. For example, in an orchestra, each player faces the conductor during performance, and thus the RIR is corrected such that the front of the RIR faces toward the conductor.

On the stage of FIG. 6, the positions of the players are set at 96 locations. Thus, the number of all the combinations of paths among the players is calculated by a permutation of selecting any two of the 96 locations as expressed by formula (1) below.

P(96,2)=96×95=9120 (1)

Thus, for the information processing device 113 that performs acoustic processing using the BRIR, a BRIR is prepared for each of the 9120 paths.

By performing acoustic processing using the BRIR from the player M to the player N, the player N feels as if the played sound of the player M was heard from the position of the player M. Moreover, the player N can hear the played sound of the player M with a reproduced initial reflected sound or rear reverberant sound in the virtual concert hall.

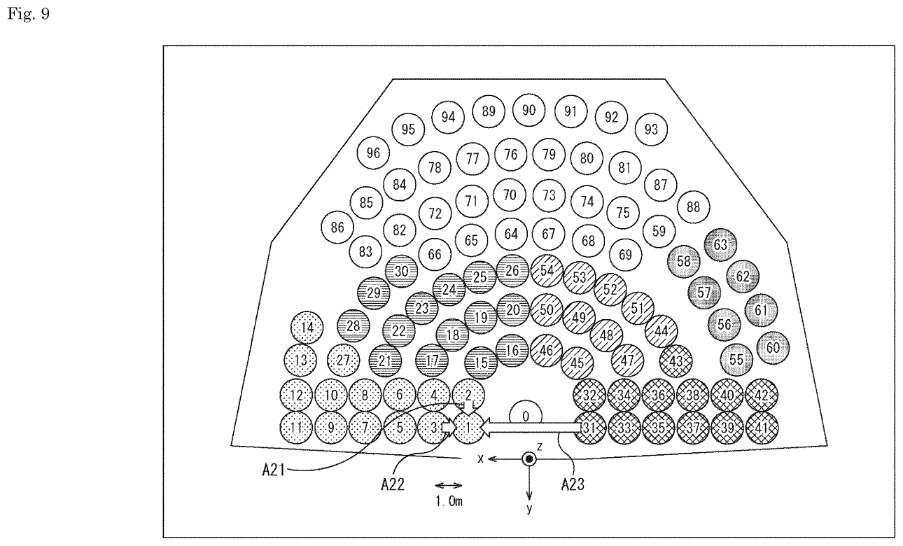

FIG. 9 shows an example of how a played sound is heard.

For the player of the first violin 1 at the position P1, the played sound of the player of a first violin 2 at the position P2 is subjected to acoustic processing based on the BRIR from the player 2, which has the sound source at the position P2, to the player 1, so that the sound is heard substantially from the left of the player 1 as indicated by an arrow A21 of FIG. 9. The front of the player of the first violin 1 is directed toward the position P0 of the conductor.

Moreover, the played sound of the player of a first violin 3 at the position P3 is subjected to acoustic processing based on the BRIR from the player 3, which has the sound source at the position P3, to the player 1, so that the played sound is heard substantially from the back of the player 1 as indicated by an arrow A22.

The played sound of the player of a viola 1 at the position P31 is subjected to acoustic processing based on the BRIR from the player 31, which has the sound source at the position P31, to the player 1, so that the sound is heard from a position slightly remote substantially from the front of the player 1 as indicated by an arrow A23.

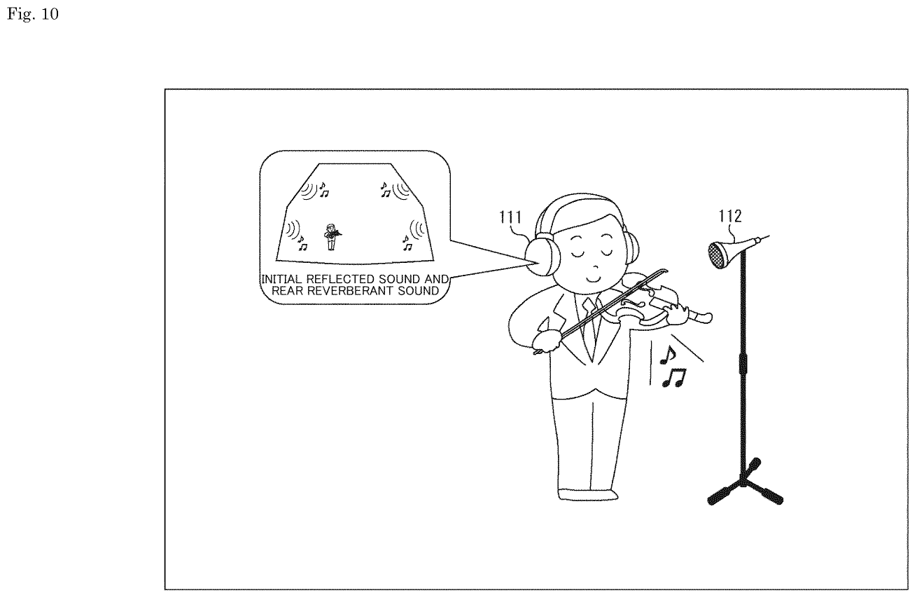

FIG. 10 illustrates an example of how the played sound of a player is heard.

For example, open-type headphones capable of collecting a sound from the outside with the output of a reproduced sound is used as the headphones 111. This allows the player to hear an actually played sound of the player as a direct sound.

For the acoustic signal of a played sound of the player, acoustic processing is performed using the BRIR representing the transfer characteristics of an initial reflected sound and a rear reverberant sound except for a direct sound. By using the open-type headphones as the headphones 111, the player in the booth can directly hear a played sound of the player, so that the BRIR representing the transfer characteristics of a sound other than a direct sound is used for acoustic processing. By performing acoustic processing using the BRIR representing the transfer characteristics of an initial reflected sound and a rear reverberant sound, as indicated by the balloon of FIG. 10, a played sound is output from the headphones 111 with the reproduced initial reflected sound or rear reverberant sound of a played sound of the player in the virtual concert hall.

By listening to an initial reflected sound or a rear reverberant sound of a played sound of the player in the virtual concert hall, the player can obtain proper acoustic feedback from the initial reflected sound and the rear reverberant sound while listening to an actually played sound of the player.

Closed-type headphones may be used as the headphones 111. In this case, for the acoustic signal of a played sound of the player, acoustic processing is performed using the BRIR representing the transfer characteristics of a direct sound, an initial reflected sound, and a rear reverberant sound. Hereinafter, open-type headphones are used as the headphones 111, and for the acoustic signal of a played sound of the player, acoustic processing is performed using the BRIR representing the transfer characteristics of an initial reflected sound and a rear reverberant sound except for a direct sound.

Method of Obtaining the BRIR

The BRIR is obtained by a measurement using a dummy head in a real concert hall or orchestra rehearsal room or a numerical calculation using an acoustic simulation.

In the acoustic simulation, the concert hall and human body models are simultaneously used to directly obtain a BRIR. Alternatively, an RIR and an HRIR that are obtained by different methods are combined in the above-mentioned manner, so that a BRIR is obtained. The RIR and HRIR used for the combination are obtained by a measurement or an acoustic simulation.

According to the method of convolution, an HRIR that is information about a time domain may be used, an HRTF (Head Related Transfer Function) that is information about a frequency domain may be used, or both of the HRIR and the HRTF may be used.

### 2. Configuration of Each Device

### Configuration Example of Overall Remote Ensemble System

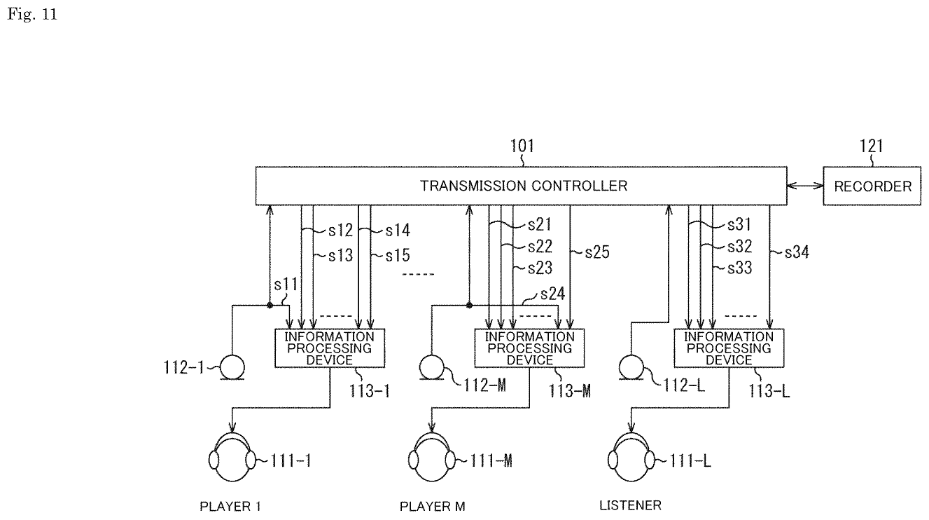

FIG. 11 is a block diagram illustrating a configuration example of the remote ensemble system.

The example of FIG. 11 is a configuration example in which a remote ensemble is performed by M players, that is, the players 1 to M. For listeners such as a conductor and a spectator who do not play any instruments, the same devices as the players are prepared.

In the booth of the player 1, the headphones 111-1, the microphone 112-1, and the information processing device 113-1 are provided. In the booth of the player M, headphones 111-M, a microphone 112-M, and an information processing device 113-M are provided. In the booth of a listener, headphones 111-L, a microphone 112-L, and an information processing device 113-L are provided.

These devices are connected to the transmission controller 101. To the transmission controller 101, a recorder 121 for recording the played sounds of the players is connected.

The microphone 112-1 collects a played sound of the player 1 and acquires an acoustic signal s11 of the played sound of the player 1. The acoustic signal s11 is input to the information processing device 113-1 while being transmitted to the transmission controller 101.

Acoustic signals s12 to 15 are input with the acoustic signal s11 to the information processing device 113-1. The acoustic signal s12 is an acoustic signal of a played sound of the player 2, and the acoustic signal s13 is an acoustic signal of a played sound of the player 3. The acoustic signal s14 is an acoustic signal of a played sound of the player M, and the acoustic signal s15 is an acoustic signal of a voice of the listener. If the listener is a conductor, the acoustic signal s15 is an acoustic signal of an instruction voice of the conductor.

The information processing device 113-1 convolves a BRIR from the player 1 to the player 1, for the acoustic signal s11. The BRIR from the player 1 to the player 1 is, as described above, a BRIR representing the transfer characteristics of an initial reflected sound and a rear reverberant sound except for a direct sound.

For the acoustic signal s12, a BRIR from the player 2 to the player 1 is convolved, whereas for the acoustic signal s13, a BRIR from the player 3 to the player 1 is convolved. For the acoustic signal s14, a BRIR from the player M to the player 1 is convolved. If the listener is a conductor, a BRIR from the position of the conductor to the player 1 is convolved for the acoustic signal s15.

The information processing device 113-1 generates a 2-channel reproduced signal including an L signal and an R signal on the basis of the acoustic signals s11 to 15 with the convoluted BRIRs and causes sounds including a played sound and an instruction voice to be output from the headphones 111-1.

The same processing is performed in the booths of other players. Specifically, the microphone 112-M collects a played sound of the player M and acquires an acoustic signal s24 of the played sound of the player M. The acoustic signal s24 is input to the information processing device 113-M while being transmitted to the transmission controller 101.

Acoustic signals s21 to 23 and 25 are input with the acoustic signal s24 to the information processing device 113-M. The acoustic signal s21 is an acoustic signal of a played sound of the player 1, and the acoustic signal s22 is an acoustic signal of a played sound of the player 2. The acoustic signal s23 is an acoustic signal of a played sound of the player 3, and the acoustic signal s25 is an acoustic signal of a voice of the listener.

For the acoustic signal s24, the information processing device 113-M convolves a BRIR from the player M to the player M. The BRIR from the player M to the player M is, as described above, a BRIR representing the transfer characteristics of an initial reflected sound and a rear reverberant sound except for a direct sound.

For the acoustic signal s21, a BRIR from the player 1 to the player M is convolved, whereas for the acoustic signal s22, a BRIR from the player 2 to the player M is convolved. For the acoustic signal s23, a BRIR from the player 3 to the player M is convolved. If the listener is a conductor, a BRIR from the position of the conductor to the player M is convolved for the acoustic signal s25.

The information processing device 113-M generates a reproduced signal on the basis of the acoustic signals s21 to 25 with the convoluted BRIRs and causes sounds including a played sound and an instruction voice to be output from the headphones 111-M.

The same processing is performed in the booth of the listener. Specifically, the microphone 112-L collects an instruction voice of the conductor and acquires an acoustic signal of the instruction voice. The acoustic signal of the instruction voice is transmitted to the transmission controller 101. If the listener is a conductor, the microphone 112-L is used. If the listener is a spectator, the microphone 112-L is not used.

The conductor can provide instructions to orchestra members by using the microphone 112-L. For the acoustic signal of the instruction voice of the conductor, the BRIR from the position of the conductor to each player is convolved by the information processing device 113 provided in the booth of each player. Thus, each player can play while feeling a sense of distance and a sense of direction from an instruction or a gesture by the conductor.

Acoustic signals s31 to 34 are input to the information processing device 113-L. The acoustic signal s31 is an acoustic signal of a played sound of the player 1, and the acoustic signal s32 is an acoustic signal of a played sound of the player 2. The acoustic signal s33 is an acoustic signal of a played sound of the player 3, and the acoustic signal s34 is an acoustic signal of a played sound of the player M.

For the acoustic signal s31, a BRIR from the player 1 to the position of the listener is convolved, whereas for the acoustic signal s32, a BRIR from the player 2 to the position of the listener is convolved. For the acoustic signal s33, a BRIR from the player 3 to the position of the listener is convolved, whereas for the acoustic signal s34, a BRIR from the player M to the position of the listener is convolved.

The information processing device 113-L generates a reproduced signal on the basis of the acoustic signals s31 to 34 with the convoluted BRIRs and causes a played sound to be output from the headphones 111-L.

The transmission controller 101 receives the acoustic signal obtained through the microphone 112 provided in each of the booths and transmits the acoustic signal to the information processing device 113 provided in each of the booths. Moreover, the transmission controller 101 causes the recorder 121 to record the received acoustic signal.

In the case of reproduction without the need for a real-time operation, for example, when a listener listens to a played sound at a different date and time from the date and time of a remote ensemble, the acoustic signal recorded in the recorder 121 is read as appropriate.

### Configuration Example of Transmission Controller

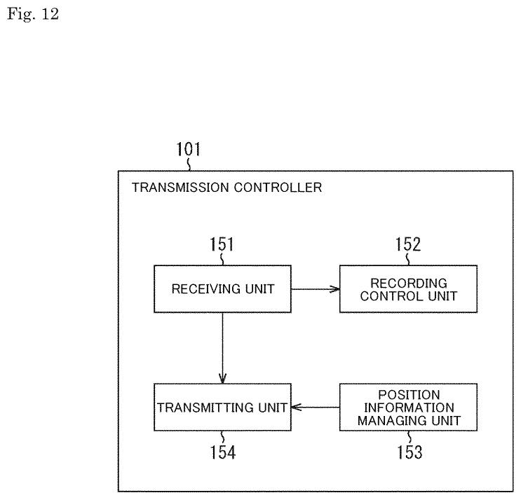

FIG. 12 is a block diagram illustrating a configuration example of the transmission controller 101. At least some of the functional units of FIG. 12 are implemented by executing a program by a CPU installed in a PC or the like that constitutes the transmission controller 101.

As illustrated in FIG. 12, the transmission controller 101 is configured with a receiving unit 151, a recording control unit 152, a position information managing unit 153, and a transmitting unit 154.

The receiving unit 151 receives an acoustic signal transmitted from the microphone 112 used by each player and outputs the acoustic signal to the recording control unit 152 and the transmitting unit 154.

The recording control unit 152 causes the recorder 121 to record the acoustic signal supplied from the receiving unit 151.

The position information managing unit 153 manages position information through communications or the like with the information processing device 113. The position information is information indicating the positions (coordinates) of players and listeners on the virtual concert hall. The position information managed by the position information managing unit 153 is supplied to the transmitting unit 154.

The transmitting unit 154 transmits, to the information processing device 113 provided in each of the booths, the acoustic signal supplied from the receiving unit 151 and the position information supplied from the position information managing unit 153.

### Configuration Example of Information Processing Device

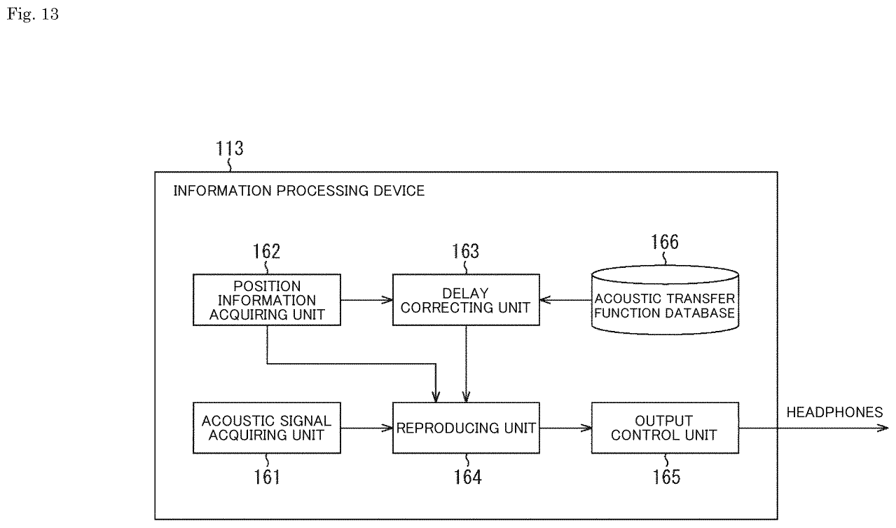

FIG. 13 is a block diagram illustrating a configuration example of the information processing device 113. At least some of the functional units of FIG. 13 are implemented by executing a program by a CPU installed in a PC or the like that constitutes the information processing device 113.

As illustrated in FIG. 13, the information processing device 113 is configured with an acoustic signal acquiring unit 161, a position information acquiring unit 162, a delay correcting unit 163, a reproducing unit 164, an output control unit 165, and an acoustic transfer function database 166.

The acoustic signal acquiring unit 161 acquires an acoustic signal of a played sound collected by the microphone 112. Furthermore, the acoustic signal acquiring unit 161 acquires an acoustic signal transmitted from the transmission controller 101. The acoustic signal acquired by the acoustic signal acquiring unit 161 is supplied to the reproducing unit 164.

The position information acquiring unit 162 acquires position information transmitted from the transmission controller 101. The position information acquired by the position information acquiring unit 162 is supplied to the delay correcting unit 163 and the reproducing unit 164.

The delay correcting unit 163 corrects a BRIR used for acoustic processing, on the basis of the transmission delay time of the acoustic signal. A BRIR corresponding to the position of each player or a listener is corrected, the BRIR being acquired from the acoustic transfer function database 166 on the basis of the position information supplied from the position information acquiring unit 162.

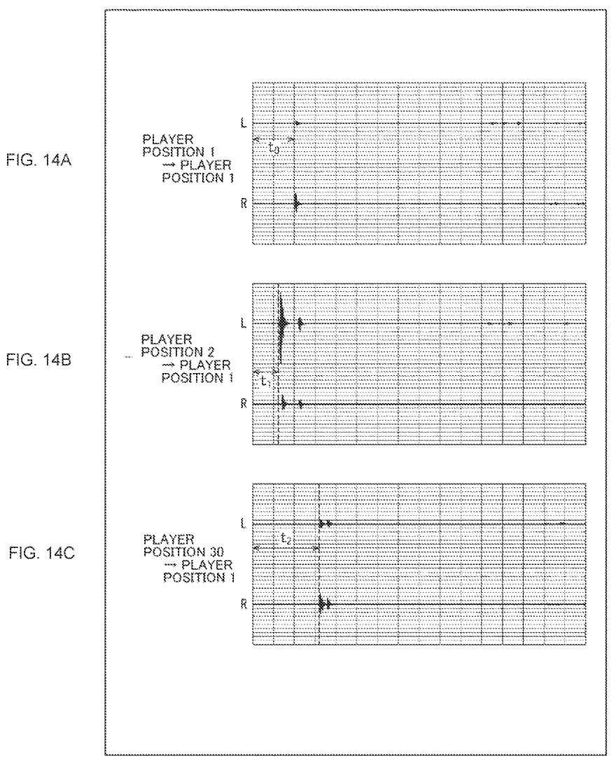

FIG. 14 shows an example of BRIRs used for acoustic processing. In A to C of FIG. 14, an upper waveform (L) represents a BRIR for a left ear and a lower waveform (R) represents a BRIR for a right ear. The horizontal axis represents time.

A in FIG. 14 indicates the part of the initial time of the BRIR from the player 1 (the player at the position P1) to the player 1. The BRIR from the player 1 to the player 1 is, as described above, a BRIR representing the transfer characteristics of an initial reflected sound and a rear reverberant sound except for the direct sound of a played sound of the player 1. The initial reflected sound and the rear reverberant sound of a played sound of the player 1 reach the player 1 after a delay of a time t₀ from the sound emission.

B in FIG. 14 indicates the part of the initial time of the BRIR from the player 2 (the player at the position P2) to the player 1. The direct sound of the player 2 reaches the player 1 after a delay of a time t₁ from the sound emission. The time t₁ is shorter than the time to.

C in FIG. 14 indicates the part of the initial time of the BRIR from the player 30 (the player at the position P30) to the player 1. The direct sound of the player 30 reaches the player 1 after a delay of a time t₂ from the sound emission. The time t₂ is longer than the time to because of a certain distance between the position P1 and the position P30.

If an inevitable delay occurs in the transmission of the acoustic signal of a played sound of a player performing with the player 1 because of a transmission delay or the like of a network, the played sound of the player performing with the player 1 may be output from the headphones 111 after a delay when the acoustic signal of the played sound is reproduced as it is. In this case, for the player, coordinated performance with the other player is difficult.

No sound waves theoretically propagate earlier than a direct sound propagating through the shortest path between players. Thus, a response from a time 0 of the BRIR used for acoustic processing to the time t₁ or the time t₂ is a 0 response, the time t₁ or t₂ corresponding to the propagation time of the direct sound.

For example, if the delay time of the transmission of the acoustic signal is denoted as tₓ and the shorter time of the t₁ and tₓ is denoted as t_{y}, the delay correcting unit 163 corrects the BRIR from the player 2 to the player 1 by cutting a response part from the time 0 to the time t_{y} of the BRIR from the player 2 to the player 1.

Also for other BRIRs, a correction is made by cutting the response part of the smaller one of the delay time of the transmission of the acoustic time and the propagation time of a direct sound.

If the acoustic signal is reproduced by using the corrected BRIR, a played sound is output from the headphones 111 at a time when the delay time of the transmission of the acoustic signal is partially or entirely complemented. Thus, an inevitable transmission delay of a network can be replaced with the propagation time of a sound wave over a distance between players in a virtual concert hall. This can reduce the delay of a played sound that is output from the headphones 111, the delay being caused by a transmission delay of the acoustic signal.

The BRIR corrected by the delay correcting unit 163 of FIG. 13 is supplied to the reproducing unit 164.

The reproducing unit 164 acts as an acoustic processing unit that performs acoustic processing on the acoustic signal supplied from the acoustic signal acquiring unit 161. By performing the acoustic processing, the BRIR corrected by the delay correcting unit 163 is convolved to the acoustic signal. The convolution of the BRIR is performed by multiplying the acoustic signal by a coefficient constituting the BRIR and adding the result of multiplication. The acoustic signal obtained by performing the acoustic processing is supplied to the output control unit 165.

The output control unit 165 causes a sound corresponding to the acoustic signal supplied from the reproducing unit 164 to be output from the headphones 111.

In the acoustic transfer function database 166, BRIRs and RIRs that correspond to a plurality of positions with respect to positions on the virtual concert hall are stored. BRIRs used for convolution are acquired from, for example, the transmission controller 101 or a server on the Internet and are stored in the acoustic transfer function database 166. BRIRs may be acquired from external devices such as a server on the Internet during acoustic processing.

Alternatively, BRIRs may be synthesized by the transmission controller 101 or the information processing device 113 through the convolution of an HRIR and an RIR that correspond to the direction of the RIR. The convolution of the HRIR and the RIR does not need to be performed in real time when the BRIR is convolved to the acoustic signal. The convolution may be performed only when a player or the like starts using the information processing device 113. If BRIRs are synthetized by the information processing device 113, the database of RIRs and HRIRs is stored in the acoustic transfer function database 166. BRIRs are synthesized by using the database of HRIRs suitable for, for example, a player using the information processing device 113, thereby optimally synthesizing the BRIRs for each of the players. Convolution is performed using BRIRs optimized for the players, thereby improving the accuracy of, for example, a sense of direction perceived by each player from a sound output from the headphones 111.

### 3. Operation of Each Device

The operations of the transmission controller 101 and the information processing device 113 that are configured thus will be described below.

Operation of Transmission Controller

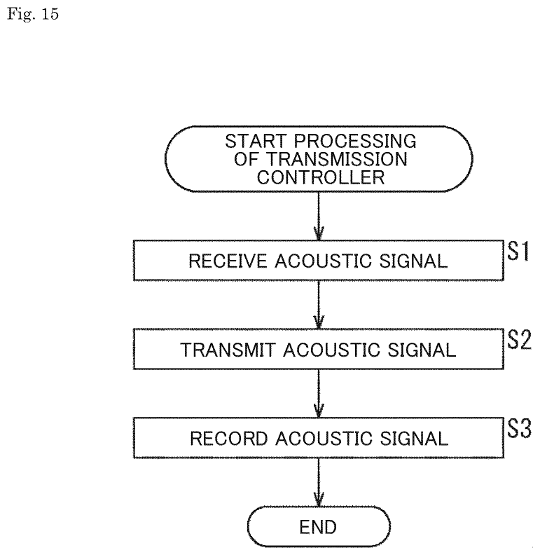

Referring to the flowchart of FIG. 15, the processing of the transmission controller 101 will be described below.

In step S1, the receiving unit 151 receives the acoustic signal acquired by the microphone 112.

In step S2, the transmitting unit 154 transmits the acoustic signal to the information processing devices 113 used by the players and the listener. Position information about the players and the listener may be transmitted with the acoustic signal to the information processing devices 113 or may be transmitted to the information processing devices 113 before the start of a remote ensemble.

In step S3, the recording control unit 152 causes the recorder 121 to record the acoustic signal. The foregoing processing is performed each time the acoustic signal is transmitted from the microphone 112.

Operation of Information Processing Device

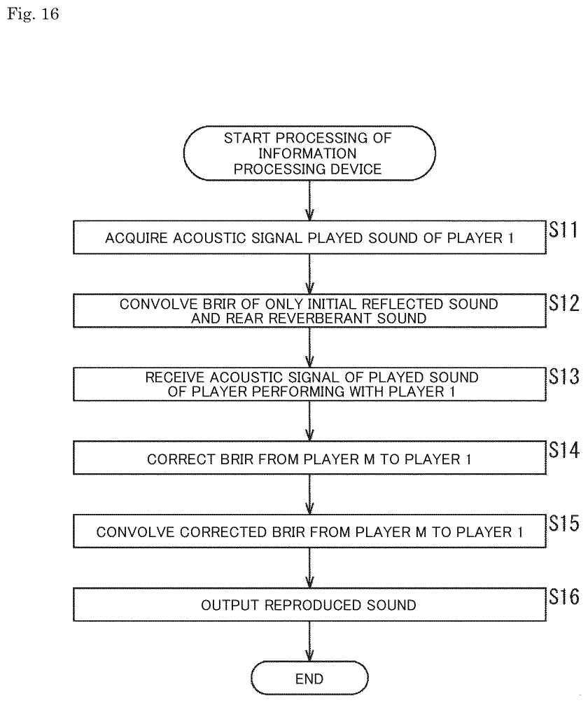

Referring to the flowchart of FIG. 16, the processing of the information processing device 113-1 used by the player 1 will be described below.

In step S11, the acoustic signal acquiring unit 161 acquires the acoustic signal of a played sound of the player 1, the sound being collected by the microphone 112-1.

In step S12, the reproducing unit 164 convolves the BRIR representing the transfer characteristics of only an initial reflected sound and a rear reverberant sound (the BRIR from the player 1 to the player 1), to the acoustic signal of the played sound of the player 1.

In step S13, the acoustic signal acquiring unit 161 receives the acoustic signal of a played sound of a player performing with the player 1, the acoustic signal being transmitted from the transmission controller 101. The acoustic signal of a voice of the listener is also received as appropriate with the acoustic signal of the played sound of the player performing with the player 1.

In step S14, the delay correcting unit 163 corrects the BRIR from the player M to the player 1 on the basis of a delay time in the transmission of the acoustic signal of a played sound of the player M.

In step S15, the reproducing unit 164 convolves the BRIR from the player M to the player 1 to the acoustic signal of the played sound of the player M after the BRIR is corrected by the delay correcting unit 163.

After the processing of step S14 and step S15 is performed for all the players and the listener, in step S16, the output control unit 165 outputs a reproduced sound corresponding to the acoustic signal having been subjected to acoustic processing by the reproducing unit 164.

After the reproduced sound is output, the foregoing processing is repeatedly performed. Also in the information processing devices 113 used by other players and listeners, the same processing as the processing of FIG. 16 is performed by using BRIRs corresponding to the positions of other players and listeners.

As described above, by performing acoustic processing using the BRIR according to the acoustic characteristics of the virtual concert hall and the relative positions of the players on the virtual concert hall, each player can obtain acoustic feedback about the played sounds of other players as in performance in a real concert hall.

By performing acoustic processing using the BRIR representing the transfer characteristics of an initial reflected sound and a rear reverberant sound of a played sound of the player, the player can obtain acoustic feedback about the played sound as in performance in a real concert hall.

Thus, each player can achieve high-level performance as in a real ensemble in a concert hall.

### 4. Modification Example

Configuration of Remote Ensemble System

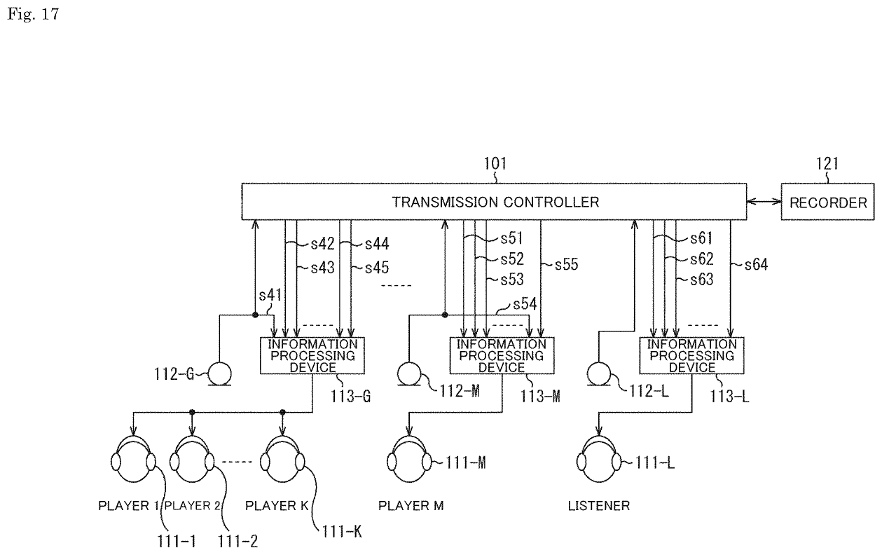

FIG. 17 illustrates another configuration example of the remote ensemble system.

Among configurations illustrated in FIG. 17, the same configurations as those described with reference to FIG. 11 are denoted by the same reference characters. The repeated description will be omitted as appropriate.

The remote ensemble system in FIG. 17 is a system used when a group consisting of players 1 to K (K is any number smaller than M) among M players performs in the same space. The group includes, for example, a plurality of players located close to one another on a virtual concert hall.

In the space where the group consisting of the players 1 to K performs, headphones 111-1 to 111-K, a microphone 112-G, and an information processing device 113-G are provided.

The headphones 111-1 to 111-K are put on the heads of the players 1 to K, respectively.

The microphone 112-G collects played sounds of the players 1 to K and acquires an acoustic signal s41 of the played sounds of the group. The acoustic signal s41 is input to the information processing device 113-G while being transmitted to the transmission controller 101.

Acoustic signals s42 to 45 are input with the acoustic signal s41 to the information processing device 113-G. The acoustic signals s42 to 44 are the acoustic signals of played sounds of the players K+1 to M, and the acoustic signal s45 is an acoustic signal of a voice of a listener.

If open-type headphones are put on the heads of all the players 1 to K as the headphones 111-1 to 111-K, the information processing device 113-G convolves, to the acoustic signal s41, a BRIR representing the transfer characteristics of an initial reflected sound and a rear reverberant sound. In this case, the BRIR corresponding to an intermediate position of the positions of the players 1 to K constituting the group. On the basis of the positions of the players 1 to K, for example, the center position of the positions of the players 1 to K is determined as the intermediate position.

If closed-type headphones are put on the heads of all the players 1 to K as the headphones 111-1 to 111-K, the BRIR representing the transfer characteristics of an initial reflected sound and a rear reverberant sound is convolved to the acoustic signal s41. Open-type headphones and closed-type headphones are not to be used in a mixed manner as the headphones 111-1 to 111-K.

For the acoustic signals s42 to 45, BRIRs corresponding to the positions of the players and listener are convolved.

The information processing device 113-G generates a reproduced signal on the basis of the acoustic signals s41 to 45 with the convoluted BRIRs and causes sounds including a played sound and an instruction voice to be output from the headphones 111-1 to 111-K.

The microphone 112-M collects a played sound of the player M and acquires an acoustic signal s54 of the played sound of the player M. The acoustic signal s54 is input to the information processing device 113-M while being transmitted to the transmission controller 101.

Acoustic signals s51 to 53 and 55 are input with the acoustic signal s54 to the information processing device 113-M. The acoustic signal s51 is an acoustic signal of played sounds of the group consisting of the players 1 to K, and the acoustic signal s52 is an acoustic signal of a played sound of the player K+1. The acoustic signal s53 is an acoustic signal of a played sound of the player K+2, and the acoustic signal s55 is an acoustic signal of a voice of the listener.

For the acoustic signal s54, the information processing device 113-M convolves a BRIR from the player M to the player M.

For the acoustic signal s51, a BRIR corresponding to an intermediate position of the positions of the players 1 to K. For the acoustic signals s52 to 55, BRIRs corresponding to the positions of the players and listener are convolved.

The information processing device 113-M generates a reproduced signal on the basis of the acoustic signals s51 to 55 with the convoluted BRIRs and causes sounds including a played sound and an instruction voice to be output from the headphones 111-M.

Acoustic signals s61 to 64 are input to the information processing device 113-L.

The acoustic signal s61 is an acoustic signal of played sounds of the group consisting of the players 1 to K, and the acoustic signals s62 to 64 are acoustic signals of played sounds of the players K+1 to M.

For the acoustic signal s61, a BRIR corresponding to an intermediate position of the positions of the players 1 to K. For the acoustic signals s62 to 64, BRIRs corresponding to the positions of the players and listener are convolved.

The information processing device 113-L generates a reproduced signal on the basis of the acoustic signals s61 to 64 with the convoluted BRIRs and causes a played sound to be output from the headphones 111-L.

In this way, the positions of the plurality of players located close to one another on the virtual concert hall may be collectively handled as one position.

Synthesis of Acoustic Signal

In the recorder 121, an acoustic signal for a played sound of each player is recorded for each player. The acoustic signal recorded in the recorder 121 can be used for reproducing a played sound having been recorded in any recording mode or a played sound heard at any listening position.

For example, when an ensemble in a real concert hall is recorded, a microphone array of the Decca Tree technique may be used as a three-point hanging microphone used for recording.

Sound receiving points are set according to the coordinate positions and directions of microphones constituting the microphone array of the Decca Tree technique and RIRs from the positions of the players to the sound receiving points are convolved to the acoustic signal of a played sound of each play, thereby reproducing a recoding result as in the use of a microphone array of the Decca Tree technique in a real concert hall. In this case, RIRs in which the directional characteristics of the microphones are reflected are used as RIRs from the positions of the players to the sound receiving points.

Moreover, the sound receiving point is set at any seat position of a seat and a BRIR from the position of each player to the sound receiving point is convolved, thereby obtaining an acoustic signal corresponding to a recording result obtained by binaural recording performed at the seat. A sound corresponding to the acoustic signal is caused to be output from the headphones, allowing the listener to feel as if a played sound was heard in a real concert hall.

The BRIRs from the positions of the players to the sound receiving point are synthesized by convolving, for example, an RIR and an HRIR corresponding to the direction of the RIR. The BRIRs are synthesized by using the database of HRIRs suitable for a player, thereby optimally synthesizing the BRIRs for the listener. Convolution is performed using BRIRs optimized for the listener, thereby improving the accuracy of, for example, a sense of direction perceived by the listener from a sound output from the headphones 111.

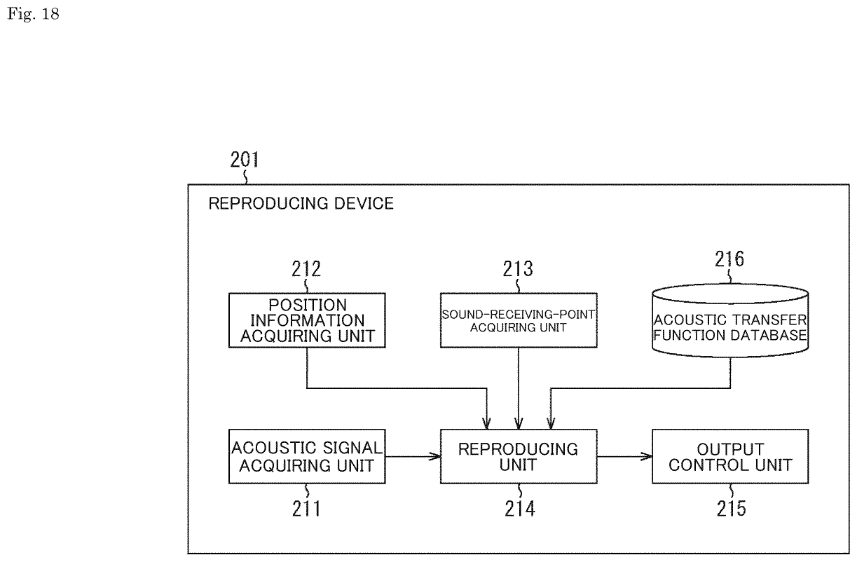

FIG. 18 is a block diagram illustrating a configuration example of a reproducing device 201 in which a recorded acoustic signal is used.

An acoustic signal acquiring unit 211 acquires the acoustic signal of a played sound of each player from the recorder 121 and outputs the signal to a reproducing unit 214.

A position information acquiring unit 212 acquires position information about players and outputs the position information to the reproducing unit 214, the position information being managed by the transmission controller 101.

A sound-receiving-point acquiring unit 213 acquires position information indicating the coordinate position and direction of the sound receiving point and outputs the position information to the reproducing unit 214. The position and direction of the sound receiving point may be set by the listener through an operation of the reproducing device 201 or may be set by the administrator of the reproducing device 201.

The reproducing unit 214 acquires, from an acoustic transfer function database 216, a BRIR corresponding to the supplied position information about the players from the position information acquiring unit 212 and the supplied position information about the sound receiving point from the sound-receiving-point acquiring unit 213.

The reproducing unit 214 performs acoustic processing on the acoustic signal of a played sound of each player by using the BRIR from the position of each player to the sound receiving point, the acoustic signal being supplied from the acoustic signal acquiring unit 211. The acoustic signal obtained by performing the acoustic processing is supplied to an output control unit 215.

The output control unit 215 causes a reproduced sound corresponding to the acoustic signal supplied from the reproducing unit 214 to be output from the headphones used by the listener. The acoustic signal supplied from the reproducing unit 214 is output from the output control unit 215 to an external device as appropriate and is recorded.

The reproducing device 201 configured thus may be provided in the transmission controller 101 of the remote ensemble system or the information processing device 113-L used by the listener.

### Example of Acoustic Processing Performed in Transmission Controller

In the foregoing example, acoustic processing using the BRIR is performed by each of the information processing devices 113. Acoustic processing using the BRIR may be performed by the transmission controller 101. In this case, at least a part of the configuration of the information processing device 113 that performs acoustic processing using the BRIR is provided in the transmission controller 101.

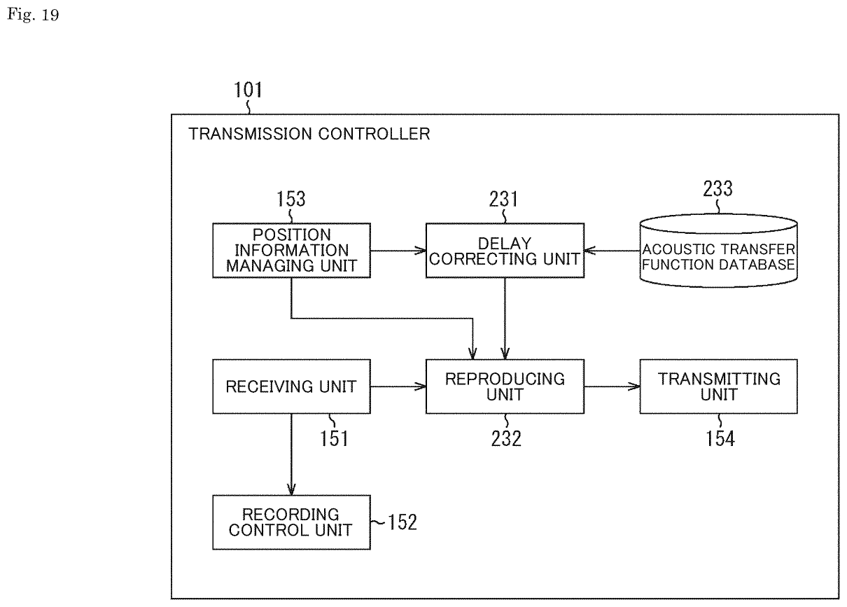

FIG. 19 illustrates another configuration example of the transmission controller 101.

The configuration of the transmission controller 101 in FIG. 19 is different from the configuration of FIG. 12 in the provision of a delay correcting unit 231, a reproducing unit 232, and an acoustic transfer function database 233. The repeated description will be omitted as appropriate.

The delay correcting unit 231, the reproducing unit 232, and the acoustic transfer function database 233 have the same functions as the delay correcting unit 163, the reproducing unit 164, and the acoustic transfer function database 166 in FIG. 13.

The delay correcting unit 231 corrects a BRIR used for acoustic processing, on the basis of the transmission delay time of the acoustic signal. A BRIR corresponding to the position of each player or a listener is corrected, the BRIR being acquired from the acoustic transfer function database 233 on the basis of the position information supplied from the position information managing unit 153. The BRIR corrected by the delay correcting unit 231 is supplied to the reproducing unit 232.

The reproducing unit 232 performs acoustic processing on the acoustic signal supplied from the receiving unit 151. By performing the acoustic processing, the BRIR corrected by the delay correcting unit 231 is convolved to the acoustic signal. The acoustic signal obtained by performing the acoustic processing is supplied to the transmitting unit 154.

The transmitting unit 154 transmits the acoustic signal supplied from the reproducing unit 232, to the information processing device 113 used by each player. The transmitting unit 154 acts as an output control unit that causes a played sound based on the acoustic signal generated by the acoustic processing to be output from the headphones 111.

Others

Different RIRs may be used for acoustic processing depending upon the kind of instrument of each player. Specifically, a BRIR to be used for acoustic processing is synthesized by convolving an RIR with the reflected radiation directional characteristics of instruments and an HRIR corresponding to the direction of the RIR.

For example, for an acoustic signal of a played sound by a player of a woodwind instrument, acoustic processing is performed by using an RIR for a woodwind instrument. For the acoustic signal of a played sound by a player of a brass instrument, acoustic processing is performed by using an RIR for a brass instrument. For example, for an acoustic signal of a played sound by a player of a stringed instrument, acoustic processing is performed by using an RIR for a stringed instrument. For the acoustic signal of a played sound by a player of a percussion instrument, acoustic processing is performed by using an RIR for a percussion instrument.

Convolution is performed using the RIR corresponding to the kind of instrument, thereby reproducing the acoustic characteristics with higher fidelity.

In the foregoing description, a remote ensemble is performed by the players of an orchestra. The processing is applicable to various ensembles performed by a plurality of players, for example, an ensemble by jazz band players or an ensemble by rock band players. In an acoustic signal to be convolved, a voice of a vocalist may be included with a played sound of an instrument.

Moreover, the processing is applicable to performing arts played by a plurality of performers. In this case, a voice of a performer is included in an acoustic signal to be convolved.

As described above, a player in an ensemble or a performer in a performing art acts as the user of the headphones, the microphone, and the information processing device that are provided in each of the booths.

A plurality of virtual concert halls may be with different acoustic characteristics and a BRIR may be prepared for each of the virtual concert halls.

### Configuration Example of Computer

The above-mentioned series of processing can be executed by hardware or software. When the series of processing is executed by software, a program constituting the software is installed from a program recording medium onto a computer built in dedicated hardware or a general-purpose personal computer.

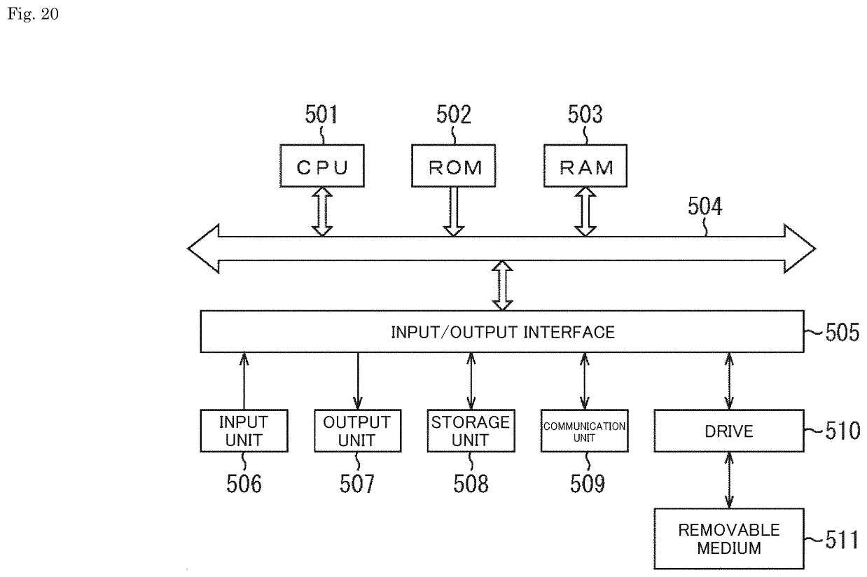

FIG. 20 is a block diagram illustrating a configuration example of hardware of a computer that executes the series of processing using a program. The transmission controller 101 and the information processing device 113 are configured with, for example, PCs that have the same configurations as the configuration of FIG. 20.

A CPU (Central Processing Unit) 501, a ROM (Read-Only Memory) 502, and a RAM (Random Access Memory) 503 are connected to one another via a bus 504.

An input/output interface 505 is additionally connected to the bus 504. An input unit 506 including a keyboard and a mouse and an output unit 507 including a display and a speaker are connected to the input/output interface 505. In addition, a storage unit 508 including a hard disk and a non-volatile memory, a communication unit 509 including a network interface, and a drive 510 that drives a removable medium 511 are connected to the input/output interface 505.

In the computer configured thus, for example, the CPU 501 performs the above-described series of processing by loading a program stored in the storage unit 508 into the RAM 503 via the input/output interface 505 and the bus 504 and executing the program.

The program executed by the CPU 501 is recorded on, for example, the removable medium 511 or is provided via wired or wireless transfer media such as a local area network, the Internet, and a digital broadcast and is installed in the storage unit 508.

The program executed by the computer may be a program that performs a plurality of steps of processing in time series in the order described in the present specification or may be a program that performs a plurality of steps of processing in parallel or at a necessary timing, for example, when a call is made.

In the present specification, a system means a collection of a plurality of constituent elements (devices, modules (components) or the like) regardless of whether all the constituent elements are located in the same casing. Thus, a plurality of devices stored in separate housings and connected via a network constitute a system, and one device including a plurality of modules stored in a housing is also a system.

The effects described in the present specification are merely exemplary and are not limited, and other effects may be obtained.

The embodiment of the present technique is not limited to the foregoing embodiment, and various changes can be made without departing from the gist of the present technique.

For example, the present technique may be configured as cloud computing in which a plurality of devices share and cooperatively process one function via a network.

In addition, each step described in the above flowchart can be executed by one device or executed in a shared manner by a plurality of devices.

Furthermore, in the case where one step includes a plurality of processes, the plurality of processes included in the one step can be executed by one device or executed in a shared manner by a plurality of devices.

### Combination Examples of Configurations

The present technique can be configured as follows:

(1)

An information processing device including: an acoustic processing unit that performs acoustic processing on an acoustic signal obtained by collecting sounds in spaces where a plurality of users performing together are located, the acoustic processing being performed to convolve the transfer characteristics of a sound according to the positional relationship among the users in a virtual space; and an output control unit that causes a sound based on a signal generated by the acoustic processing to be output from an output device used by each of the users.

(2)

The information processing device according to (1), wherein the acoustic processing unit performs the acoustic processing on the acoustic signal by using the transfer characteristics corresponding to the positional relationship between the position of the user and the positions of the other users, the acoustic signal being obtained by collecting sounds in the spaces where the other users are located.

(3)

The information processing device according to (1) or (2), wherein the acoustic processing unit performs the acoustic processing on the acoustic signal by using the transfer characteristics representing the characteristics of a reflected sound of a sound having a sound source at the position of the user on the virtual space, the acoustic signal being obtained by collecting a sound in the space where the user is located.

(4)

The information processing device according to any one of (1) to (3), wherein the transfer characteristics are BRIRs.

(5)

The information processing device according to any one of (1) to (4), further including a receiving unit that receives the acoustic signal transmitted from an external controller configured to control the transmission of the acoustic signal; and a correcting unit that corrects the transfer characteristics on the basis of the transmission delay time of the acoustic signal,
wherein
the acoustic processing unit performs the acoustic processing by using the corrected transfer characteristics.
   (6)

The information processing device according to any one of (1) to (5), wherein the acoustic processing unit performs the acoustic processing on the acoustic signal by using the transfer characteristics corresponding to positions determined on the basis of the positions of the plurality of users on the virtual space, the acoustic signal being obtained by collecting sounds in a space where the group of the plurality of users is located.

(7)

The information processing device according to any one of (1) to (6), further including a receiving unit that receives the acoustic signal obtained by collecting sounds in the spaces where the users are located; and
a transmitting unit that transmits a signal generated by the acoustic processing on the received acoustic signal, to a device used by each of the users, the output device being connected to the device.
   (8)

The information processing device according to (7), further including a recording control unit that causes a recorder to record the acoustic signal, the acoustic signal being obtained by collecting sounds in the spaces where the plurality of users are located.

(9)

The information processing device according to (8), wherein the acoustic processing unit performs the acoustic processing on the acoustic signal recorded by the recorder.

(10)

The information processing device according to any one of (1) to (9), wherein the acoustic processing unit performs the acoustic processing on the acoustic signal representing a played sound of the plurality of users.

(11)

The information processing device according to (10), wherein the virtual space is an acoustic space designed for a hall for playing an ensemble.

(12)

An information processing method that causes an information processing device to: perform acoustic processing on an acoustic signal obtained by collecting sounds in spaces where a plurality of users performing together are located, the acoustic processing being performed to convolve the transfer characteristics of a sound according to the positional relationship among the users in a virtual space; and cause a sound based on a signal generated by the acoustic processing to be output from an output device used by each of the users.

(13)

A program for causing a computer to perform processing of:
performing acoustic processing on an acoustic signal obtained by collecting sounds in spaces where a plurality of users performing together are located, the acoustic processing being performed to convolve the transfer characteristics of a sound according to the positional relationship among the users in a virtual space; and outputting a sound based on a signal generated by the acoustic processing, from an output device used by each of the users.

### REFERENCE SIGNS LIST

101 Transmission controller
111 Headphones
112 Microphone
113 Information processing device
121 Recorder
151 Receiving unit
152 Recording control unit
153 Transmitting unit
154 Position information managing unit
161 Acoustic signal acquiring unit
162 Position information acquiring unit
163 Delay correcting unit
164 Reproducing unit
165 Output control unit
166 Acoustic transfer function database
201 Reproducing device
211 Acoustic signal acquiring unit
212 Position information acquiring unit
213 Sound-receiving-point acquiring unit
214 Reproducing unit
215 Output control unit
216 Acoustic transfer function database
231 Delay correcting unit
232 Reproducing unit
233 Acoustic transfer function database

1. An information processing device comprising: an acoustic processing unit that performs acoustic processing on an acoustic signal obtained by collecting sounds in spaces where a plurality of users performing together are located, the acoustic processing being performed to convolve transfer characteristics of a sound according to a positional relationship among the users in a virtual space; and
an output control unit that causes a sound based on a signal generated by the acoustic processing to be output from an output device used by each of the users.

2. The information processing device according to claim 1, wherein the acoustic processing unit performs the acoustic processing on the acoustic signal by using the transfer characteristics corresponding to a positional relationship between a position of the user and positions of the other users, the acoustic signal being obtained by collecting sounds in the spaces where the other users are located.

3. The information processing device according to claim 1, wherein the acoustic processing unit performs the acoustic processing on the acoustic signal by using the transfer characteristics representing characteristics of a reflected sound of a sound having a sound source at a position of the user on the virtual space, the acoustic signal being obtained by collecting a sound in the space where the user is located.

4. The information processing device according to claim 1, wherein the transfer characteristics are BRIRs.

5. The information processing device according to claim 1, further comprising a receiving unit that receives the acoustic signal transmitted from an external controller configured to control transmission of the acoustic signal; and
a correcting unit that corrects the transfer characteristics on a basis of the transmission delay time of the acoustic signal,
wherein
the acoustic processing unit performs the acoustic processing by using the corrected transfer characteristics.

6. The information processing device according to claim 1, wherein the acoustic processing unit performs the acoustic processing on the acoustic signal by using the transfer characteristics corresponding to positions determined on a basis of the positions of the plurality of users on the virtual space, the acoustic signal being obtained by collecting sounds in a space where the group of the plurality of users is located.

7. The information processing device according to claim 1, further comprising a receiving unit that receives the acoustic signal obtained by collecting sounds in the spaces where the users are located; and
a transmitting unit that transmits a signal generated by the acoustic processing on the received acoustic signal, to a device used by each of the users, the output device being connected to the device.

8. The information processing device according to claim 7, further comprising a recording control unit that causes a recorder to record the acoustic signal, the acoustic signal being obtained by collecting sounds in the spaces where the plurality of users are located.

9. The information processing device according to claim 8, wherein the acoustic processing unit performs the acoustic processing on the acoustic signal recorded by the recorder.

10. The information processing device according to claim 1, wherein the acoustic processing unit performs the acoustic processing on the acoustic signal representing a played sound of each of the plurality of users.

11. The information processing device according to claim 10, wherein the virtual space is an acoustic space designed for a hall for playing an ensemble.

12. An information processing method that causes an information processing device to:
perform acoustic processing on an acoustic signal obtained by collecting sounds in spaces where a plurality of users performing together are located, the acoustic processing being performed to convolve transfer characteristics of a sound according to a positional relationship among the users in a virtual space; and
cause a sound based on a signal generated by the acoustic processing to be output from an output device used by each of the users.

13. A program for causing a computer to perform processing of;
performing acoustic processing on an acoustic signal obtained by collecting sounds in spaces where a plurality of users performing together are located, the acoustic processing being performed to convolve transfer characteristics of a sound according to a positional relationship among the users in a virtual space; and
causing a sound based on a signal generated by the acoustic processing to be output from an output device used by each of the users.
